(19) United States
(12) Patent Application Publication
(10) Pub. No.: US 2026/0218565 A1
(43) Pub. Date: Jul. 30, 2026

(54) WEATHER SEALING FOR FENESTRATION UNITS

(71) Applicant: Pella Corporation, Pella, IA (US)

(72) Inventors: Bruce Sievers, Pella, IA (US); Hunter Northway, Pella, IA (US); Jaden Vos, Pella, IA (US)

(73) Assignee: Pella Corporation, Pella, IA (US)

(21) Appl. No.: 19/189,751

(22) Filed: Apr. 25, 2025

Related U.S. Application Data
(60) Provisional application No. 63/749,777, filed on Jan. 27, 2025.

(51) Int. Cl. E06B 7/23

(52) U.S. Cl. CPC E06B 7/2305; E06B 7/2314

(57) ABSTRACT

Systems and methods for weather sealing fenestration units configured to be set into a rough opening of a building structure. The fenestration unit may include a frame having a plurality of frame members defining a perimeter where an intersection point between each frame member of the plurality of frame members defines a plurality of corners and each corner of the plurality of corners defines an intersection angle, and at least one corner seal secured to a first corner of the plurality of corners. The at least one corner seal may include a flange portion and a cut-out area defining a first corner seal angle that generally corresponds to a first intersection angle of the first corner of the fenestration unit.

### CROSS REFERENCE TO RELATED APPLICATIONS

This application claims priority to U.S. Provisional Ser. No. 63/749,777, filed Jan. 27, 2025, the disclosure of which is hereby incorporated by reference in its entirety.

### BACKGROUND

Traditional fenestration unit designs typically have an exterior nailing flange and are installed from the exterior side of the building. Such methods generally include unpackaging the fenestration unit, gauging the fenestration unit in the rough opening, and adjusting a position of the fenestration unit by inserting shims to level, plumb and square. After the fenestration unit is correctly set, the installer drives fasteners through the exterior nailing flange to secure the window, and applies flashing tape on the nailing flange, the jambs, and across the head of the window. The installer may also inject expansion foam around the perimeter of the window in the gap between the frame and rough opening to create a water-tight and air-tight weather seal.

### SUMMARY

Various examples and methods relate to corner sealing for fenestration units. In some embodiments, features of the corner seals are customized to generally correspond to the geometry of the corners of the fenestration unit. For example, the corner seals may be customized to substantially match an angle of the corner of the fenestration unit. The fenestration units may have non-rectangular geometry, including but not limited to, triangular, trapezoidal, pentagonal, hexagonal, or octagonal frames. Customization of the corner seals may improve weather sealing about the perimeter of the fenestration unit. Though not limited to such applications, the corner sealing concepts addressed herein may be particularly advantageous for interior installation applications.

According to an example (“Example 1”), a method includes creating an outline of a fenestration unit on a sheet of material, the outline including a representation of a corner of the fenestration unit and forming a corner seal into the sheet of material, wherein the corner seal includes a flange portion and a cut out area defining a corner seal angle that generally corresponds to an angle of the corner of the fenestration unit.

According to another example (“Example 2”), further to Example 1, forming the corner seal into the sheet of material includes laser cutting the corner seal into the sheet of material.

According to another example (“Example 3”), further to Example 1, forming the corner seal into the sheet of material includes locating the corner seal adjacent to the representation of the corner of the fenestration unit.

According to another example (“Example 4”), further to Example 1, the method further includes forming a tab along a perimeter of the corner seal.

According to another example (“Example 5”), further to Example 1, the method further includes creating a first designation on the template identifying the corner of the fenestration unit and a second designation identifying the corner on the outline of the fenestration unit, and optionally wherein the first and second designations are matching symbols, and optionally wherein the matching symbols are alphanumeric symbols.

According to another example (“Example 6”), further to Example 1, the method further includes removing the corner seal from the sheet of material.

According to an example (“Example 7”), a fenestration unit includes a frame having a plurality of frame members defining a perimeter, wherein an intersection point between each frame member of the plurality of frame members defines a plurality of corners and each corner of the plurality of corners defines an angle. A method of weather sealing the fenestration unit within a rough opening includes securing a first corner seal to a first corner of the plurality of corners, the first corner seal including a flange portion and a cut out area defining a first corner seal angle that generally corresponds to a first angle of the first corner of the fenestration unit, securing a second corner seal to a second corner of the plurality of corners, the second corner seal including a flange portion and a cut out area defining a second corner seal angle that generally corresponds to a second angle of the second corner of the fenestration unit, and applying a flashing tape along a portion of the frame including over at least a portion of the first corner seal and a portion of the second corner seal.

According to another example (“Example 8”), further to Example 7, the fenestration unit includes one or more fins, the method further including transitioning the fins to an extended, deployed position prior to securing the first and second corner seals to the first and second corners.

According to another example (“Example 9”), further to Example 7, the method further includes securing a third corner seal to a third corner of the plurality of corners, the third corner seal including a flange portion and a cut out area defining a third corner seal angle that generally corresponds to a third angle of the third corner of the fenestration unit.

According to another example (“Example 10”), further to Example 9, the method further includes securing a fourth corner seal to a fourth corner of the plurality of corners, the fourth corner seal including a flange portion and a cut out area defining a fourth corner seal angle that generally corresponds to a fourth angle of the fourth corner of the fenestration unit.

According to another example (“Example 11”), further to Example 10, the method further includes applying a flashing tape along a portion of the frame including over at least a portion of the third corner seal and a portion of the fourth corner seal.

According to another example (“Example 12”), further to Example 7, the method further includes stretching at least a portion of the first corner seal radially outwardly relative to the frame.

According to another example (“Example 13”), further to Example 7, the method further includes removing a tab from the first corner seal.

According to another example (“Example 14”), further to Example 7, the method further includes following a corner seal template to determine an installation sequence of the corners of the fenestration unit.

According to an example (“Example 15”), a fenestration unit includes a frame having a plurality of frame members defining a perimeter, an intersection point being between each frame member of the plurality of frame members defines a plurality of corners and each corner of the plurality of corners defines an intersection angle, and at least one corner seal secured to a first corner of the plurality of corners, the at least one corner seal including a flange portion and a cut out area defining a first corner seal angle that generally corresponds to a first intersection angle of the first corner of the fenestration unit.

According to another example (“Example 16”), further to Example 15, the frame defines a geometry including one of a rectangle, a trapezoid, a triangle, a pentagon, a hexagon, an octagon, or a combination thereof.

According to another example (“Example 17”), further to Example 15, the fenestration unit includes at least two fins and the at least one corner seal is secured to the at least two fins at an intersection point between the at least two fins.

According to another example (“Example 18”), further to Example 15, the at least one corner seal includes a flexible polymeric material.

According to an example (“Example 19”), a template for a fenestration unit includes a schematic of a perimeter of the fenestration unit including a representation of at least one corner of the fenestration unit and at least one corner seal positioned proximate to the at least one corner, the corner seal having a flange portion and a cut out area defining a first corner seal angle that generally corresponds to a first angle of the first corner of the fenestration unit.

According to another example (“Example 20”), further to Example 19, the template for the fenestration unit further includes at least one designation for each corner including at least one of arrows or alphanumeric symbols.

The foregoing examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of a fenestration unit installation from an exterior side including a weather seal system, in accordance with some embodiments;

FIG. 2A is an end view of a fin of the weather seal system of the fenestration unit of FIG. 1, in accordance with some embodiments;

FIG. 2B is an isometric view of the fin of FIG. 2A, in accordance with some embodiments;

FIG. 2C is a front view of the fin of FIG. 2A coupled to the fenestration unit of FIG. 1, in accordance with some embodiments;

FIG. 3A is a front view of an embodiment of a corner seal of the weather seal system of the fenestration unit of FIG. 1, in accordance with some embodiments;

FIG. 3B is a front view of another embodiment of a corner seal of the weather seal system of the fenestration unit of FIG. 1, in accordance with some embodiments;

FIG. 4 shows the corner seal secured to the fenestration unit of FIG. 1, in accordance with some embodiments;

FIG. 5 shows a corner seal template for the fenestration unit of FIG. 1, in accordance with some embodiments;

FIG. 6 shows a front view of a flashing tape installation for the fenestration unit of FIG. 1, in accordance with some embodiments;

FIG. 7 shows the corner seal secured to the fenestration unit with the flashing tape installed, in accordance with some embodiments;

FIG. 8A shows the corner seal secured to the fenestration unit when the fin of FIG. 2A is in a deployed configuration, in accordance with some embodiments;

FIG. 8B shows the corner seal secured to the fenestration unit when the fin of FIG. 2A is in a stowed configuration, in accordance with some embodiments;

FIG. 9 shows a corner seal template for a hexagonal embodiment of the fenestration unit of FIG. 1, in accordance with some embodiments;

FIG. 10 shows a corner seal template for a pentagonal embodiment of the fenestration unit of FIG. 1, in accordance with some embodiments;

FIG. 11 shows a corner seal template for an octagonal embodiment of the fenestration unit of FIG. 1, in accordance with some embodiments;

FIG. 12 shows a corner seal template for a triangular embodiment of the fenestration unit of FIG. 1, in accordance with some embodiments; and

FIG. 13 shows a corner seal template for a mulled fenestration unit, in accordance with some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about”, “substantially” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The terms “interior” and “exterior” are generally meant to reference opposite sides of a fenestration unit unless directly specified that “exterior” means exposed to the elements. For example, a fenestration unit installed within an interior of a building structure (e.g., a bedroom door) still has opposing “interior” and “exterior” sides as those terms are used in this patent specification, though the “exterior” is still disposed within the building structure itself.

The term “fenestration unit” is meant to cover any of a variety of products for providing venting, viewing, ingress, or egress from a building structure into which the fenestration unit is installed. Examples include doors, windows, and the like.

The term “structure” or “building” is meant to cover any of a variety of structures. Examples include single-family or multi-family homes, residential buildings, commercial buildings, and others.

The term “opening” as used in the context of a “structure” or “building” may include rough openings in the structure, including rough openings in an exterior wall or boundary of the structure or internal wall or boundary of the structure.

The term “weather sealing” or “weather seal” as used herein refers to water-tight and/or air-tight sealing about an exterior and/or interior facing sides of the fenestration unit, where, in some examples, the exterior side may be exposed to outdoor elements such as rain, snow, and the like.

Relative terms such as “upper”, “lower”, “top”, “bottom”, “horizontal,” “vertical” and the like are construed broadly and are used to describe the orientation of components relative to one another, rather than in an absolute sense, unless otherwise indicated.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

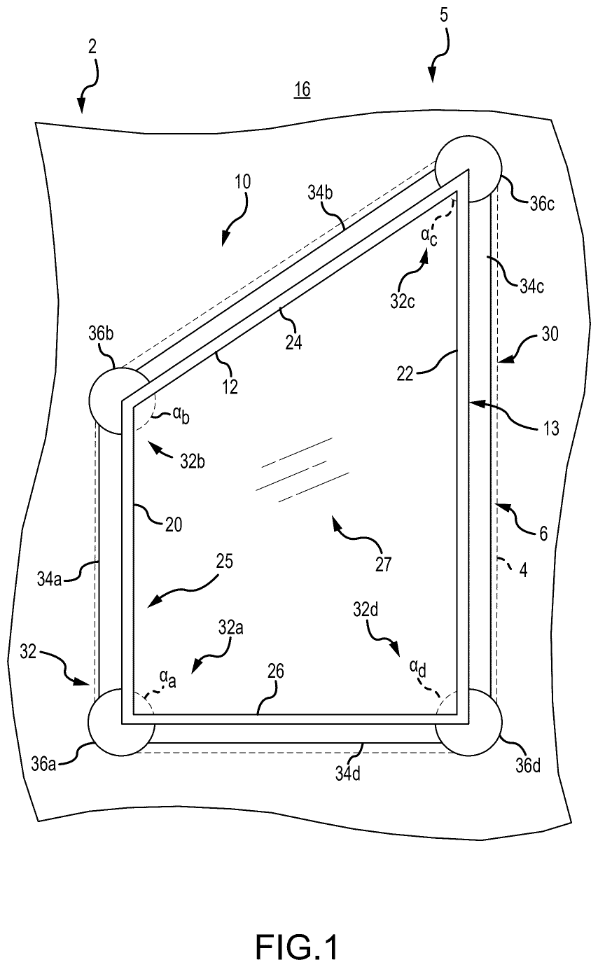

FIG. 1 is a front view of a fenestration unit installation 5 as viewed from an exterior side 16, in accordance with some embodiments. As shown, the fenestration unit installation 5 includes a fenestration unit 10 installed in a rough opening of the structure 2, including sealant or/and fasteners (not shown) for securing and anchoring the fenestration unit 10 in place within the rough opening. The rough opening is defined by a rough opening framing 4.

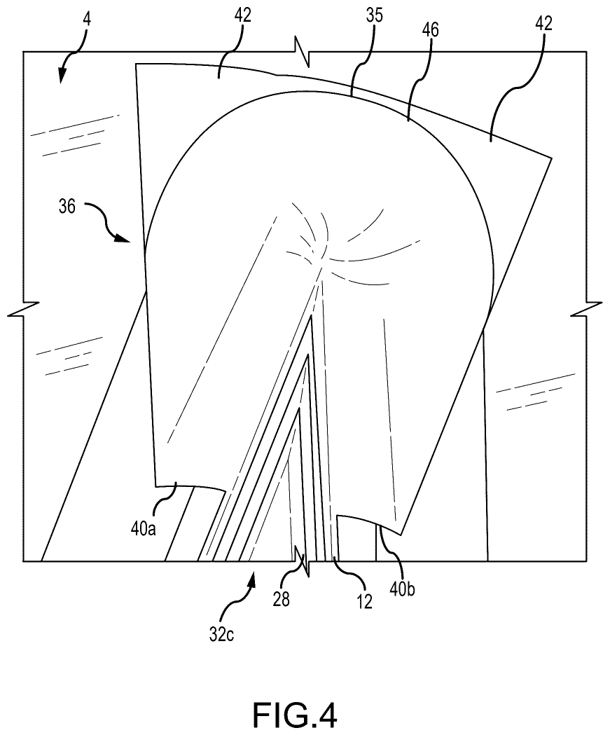

Further referring to FIG. 1, the fenestration unit 10 includes a frame 12, an interior side 14 (e.g., facing an interior side of the structure 2), the exterior side 16 opposite the interior side 14 (e.g., facing an exterior side of the structure 2), an intermediate portion 28 (FIG. 4) between the interior and exterior sides 14,16, and a perimeter 13 defined by the frame 12. The fenestration unit 10 is received in the rough opening of the structure 2 such that a gap 6 is defined around the perimeter 13 of the fenestration unit 10 between the fenestration unit 10 and the rough opening framing 4. The gap 6 may be at least partially filed with a sealant.

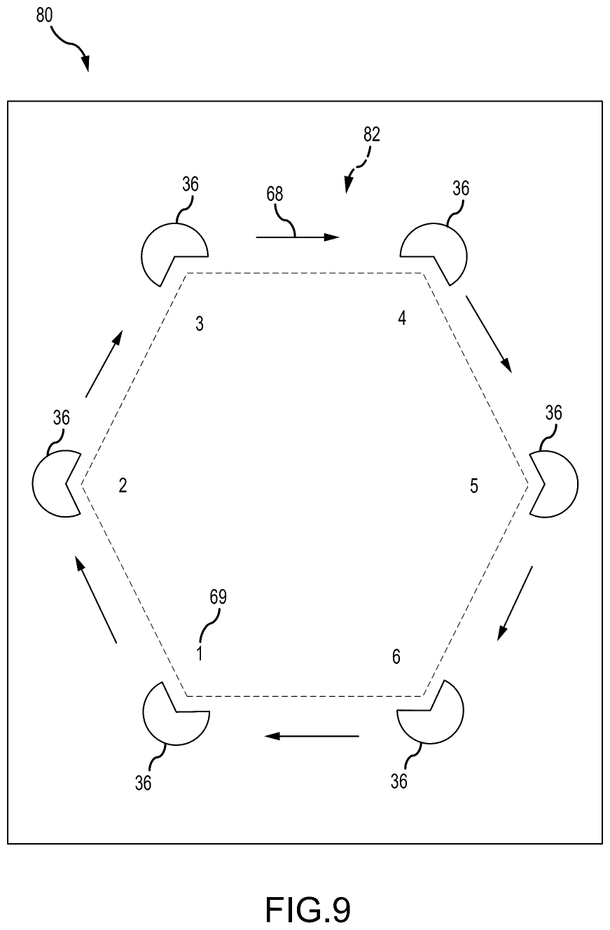

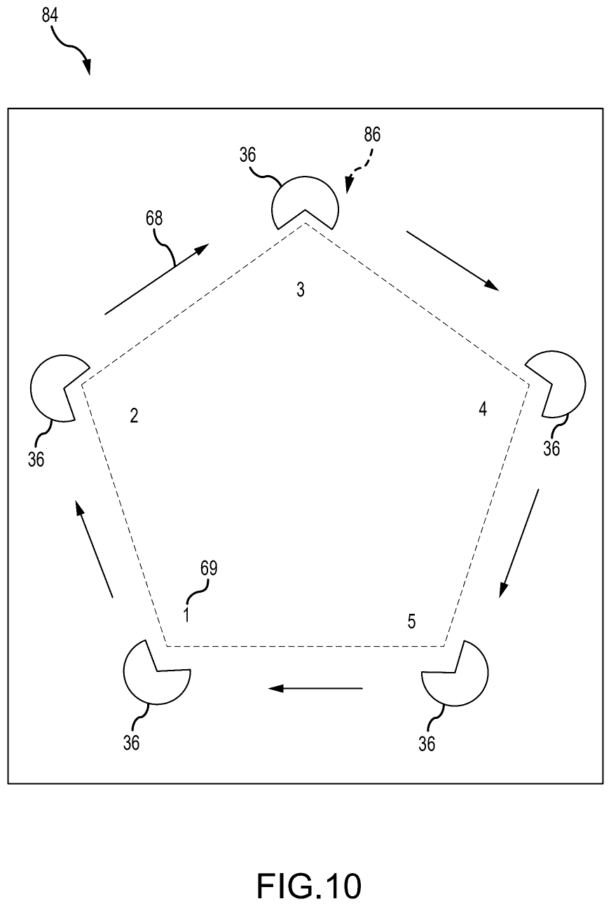

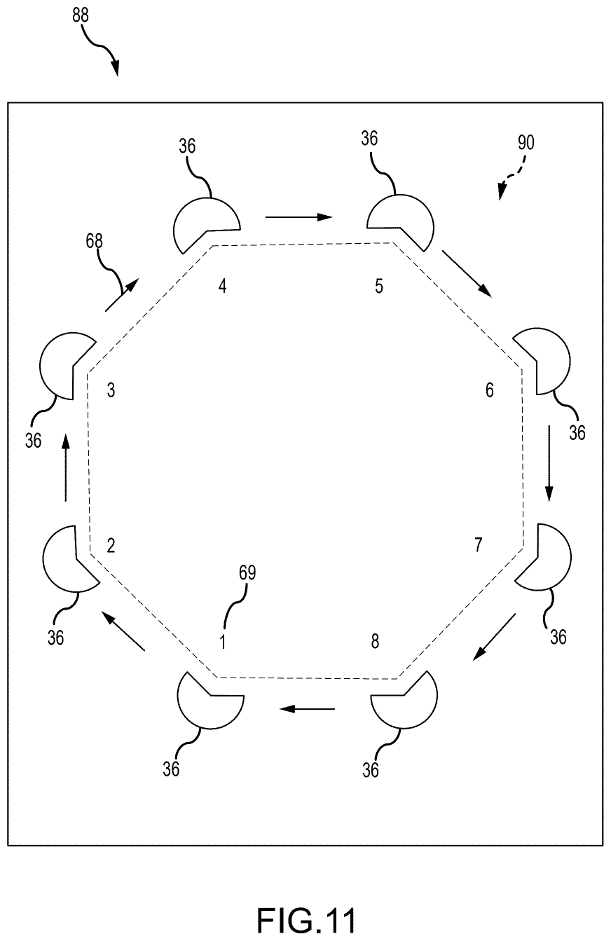

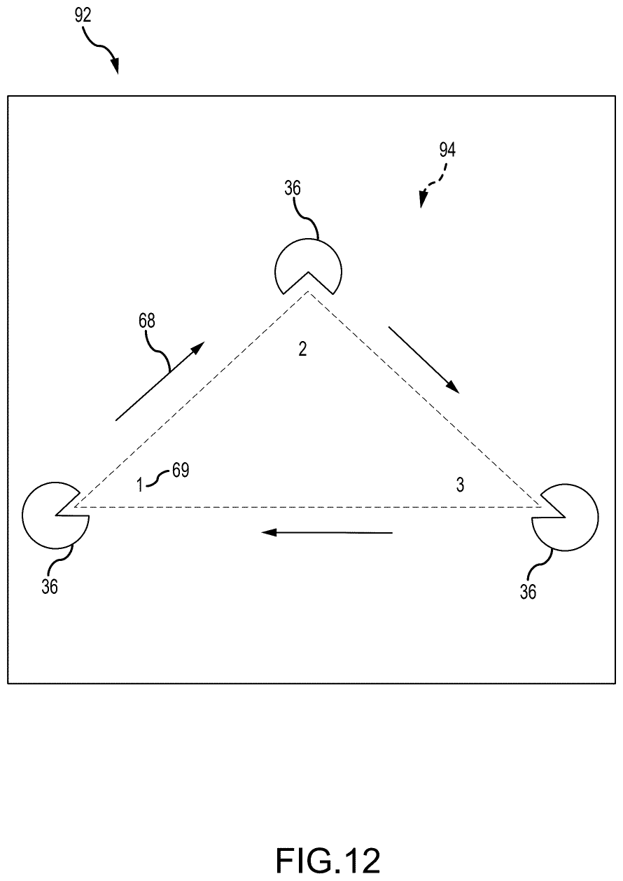

The frame 12 of fenestration unit 10 includes a plurality of frame members 25. In some embodiments, the plurality of frame members 25 includes a first side member 20 (e.g., a first jamb), a second side member 22 (e.g., a second jamb), an upper member 24 (e.g., a head), and a lower member 26 (e.g., a sill). Though a four-sided configuration of the fenestration unit 10 is shown and described by way of example in FIG. 1, other configurations (e.g., three-sided, five-sided, six-sided, curve top, circle-head, and so forth) are contemplated. As shown, the fenestration unit 10 may include a non-rectangular geometry including, but not limited to a trapezoid (FIG. 1), a hexagon (FIG. 9), a pentagon (FIG. 10), an octagon (FIG. 11), or a triangle (FIG. 12). In other examples, the frame 12 may be generally rectangular. The frame 12 defines a plurality of corners 32 at the intersection point of the plurality of frame members 25, and the number of corners 32 depends on the shape of the frame 12 (e.g., the trapezoidal fenestration unit 10 of FIG. 1 includes four corners 32), and any number (and associated angles) of corners 32 are contemplated. As shown in the example of FIG. 1, the corners 32 include a first corner 32a defined at the intersection of the first side member 20 and the lower member 26, a second corner 32b defined at the intersection of the first side member 20 and the upper member 24, a third corner 32c defined at the intersection of the second side member 22 and the upper member 24, and a fourth corner 32d defined at the intersection of the second side member 22 and the lower member 26.

The frame 12 and its components can be configured to maintain one or more glazing panels 27 or other panels, which may include sheets of glass.

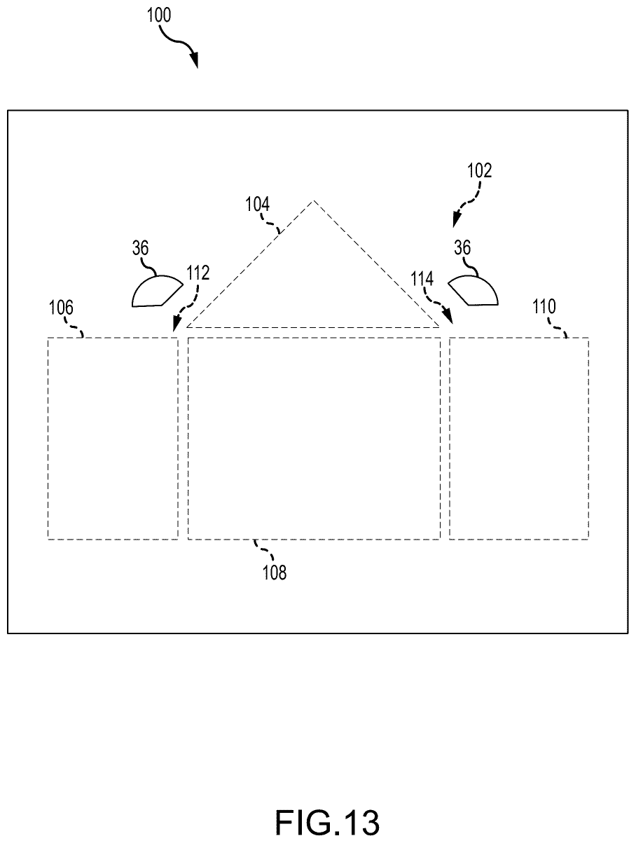

In some embodiments, and as subsequently described with respect to FIG. 13, the frame 12 may also be combined with other fenestration unit frames to form a mulled fenestration unit 102. The mulled fenestration unit 102 can include a combination of more than one fenestration unit resulting in group of shapes defining a plurality of corners.

As shown, the fenestration unit installation 5 includes a weather seal system 30 extending about the perimeter 13 of the fenestration unit 10. The weather seal system 30 is generally configured to cover the gap 6 between the fenestration unit 10 and the rough opening framing 4.

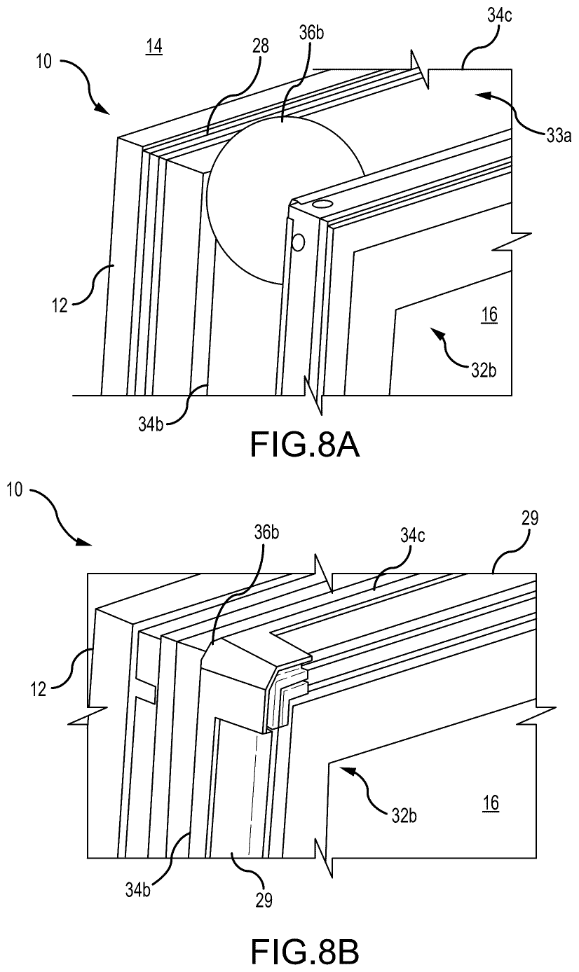

As shown in FIG. 1, the weather seal system 30 is secured about the perimeter 13 of the fenestration unit 10. The weather seal system 30 may optionally include a fin assembly comprising a plurality of fins 34 extending continuously or discontinuously along at least a portion of the plurality of frame members 25. As shown, the fins 34 may include a first fin 34a extending along at least a portion of the first side member 20, a second fin 34b extending along at least a portion of the upper member 24, a third fin 34c extending along at least a portion of the second side member 22, and a fourth fin 34d extending along at least a portion of the lower member 26. In some embodiments, each fin of the plurality of fins 34 may be biased to a deployed state or may be otherwise described as a “pop-up” fin. In various examples, the plurality of fins 34 is initially provided (e.g., shipped or transported to the installation site) in a stowed, or flattened configuration against the frame 12 of the fenestration unit 10 (e.g., as shown in FIG. 8B). The plurality of fins 34 may be held in the stowed position against the perimeter 13 of the frame 12 with a retaining assembly 29 (FIG. 8B), such as with a retaining clip or with an adhesive. In some examples, upon removal of the retaining assembly 29, the plurality of fins 34 automatically pop-up, or project outwardly from the frame 12 (e.g., at approximately 90° degrees) in a deployed, or extended position in which the plurality of fins 34 rest against the exterior surface of the structure 2 in which the rough opening (RO) is formed (e.g., as shown in FIG. 1).

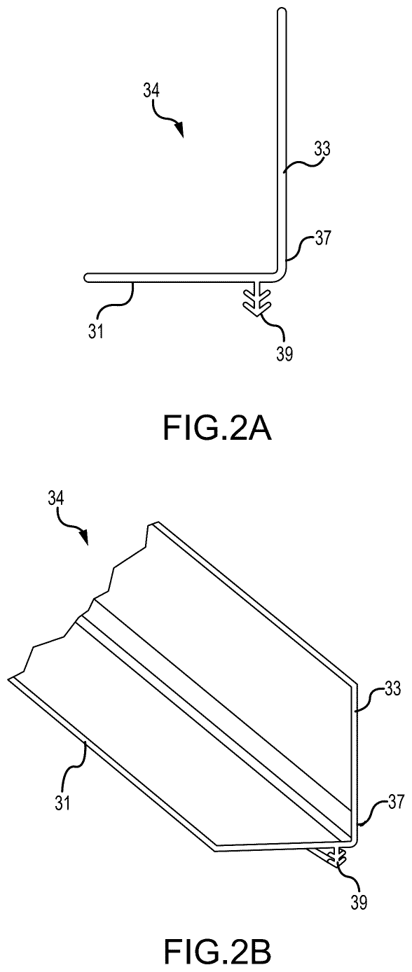

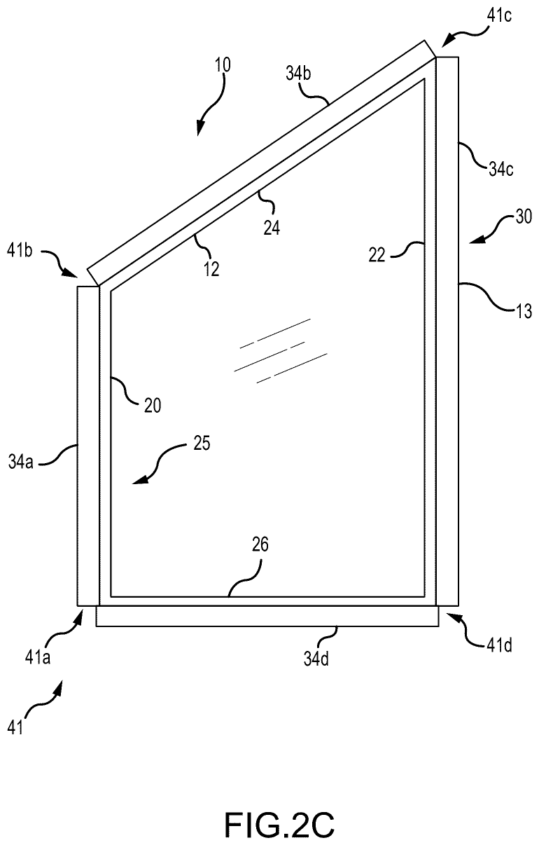

As shown in FIGS. 2A-2B, each of the plurality of fins 34 has a coupling portion 31 and a projection portion 33, with a hinge portion 37 between the coupling portion 31 and the projection portion 33. The coupling portion 31 is coupled to the perimeter 13 of the frame 12 and the projection portion 33 is biased by the hinge portion 37 to project radially outward from the perimeter 13 of the frame 12. In some embodiments, the coupling portion 31 may be coupled to the frame 12 via adhesion to the frame 12, however, other attachment methods are contemplated including a barb 39 coupling to an accessory channel (not shown) of the fenestration unit 10. The hinge portion 37 is located between the coupling portion 31 and the projection portion 33, being coupled to each respectively. The hinge portion 37 is configured to flex between the stowed, or flattened position with the projection portion 33 folded against the coupling portion 31 and the deployed, extended position with the projection portion 33 extending away from the coupling portion 31 at an angle between the coupling portion 31 and the projection portion 33 (e.g., 90 degrees, or greater than 90 degrees, such as 100 degrees).

As shown in FIG. 2C, the fins 34 may be generally rectangular in shape. The fins 34 may form an intersection point, or a fin corner 41, between adjacent fins 34 proximate to the corners 32 of the fenestration unit 10. As shown, the fin corners 41 may include a first fin corner 41a between the first fin 34a and the fourth fin 34d, a second fin corner 41b between the first fin 34a and the second fin 34b, a third fin corner 41c between the second fin 34b and the third fin 34c, a fourth fin corner 41d between the third fin 34c and the fourth fin 34d. At the fin corners 41a-41d, the respective fins 34 may have portions that are spaced apart from each other, or non-overlapping, such that a gap is formed at each fin corners 41a-41d.

The weather seal system 30 also includes corner seals 36 coupled to the frame 12 at each corner 32. The corner seals 36 may be positioned at each of the four corners 32a-32d. As shown, a first corner seal 36a is positioned at the first corner 32a, a second corner seal 36b is positioned at the second corner 32b, a third corner seal 36c is positioned at the third corner 32c, and a fourth corner seal 36d is positioned at the fourth corner 32d. The corner seals 36 may be coupled to portions of the fins 34 and positioned at the fin corners 41 to cover any gaps therein.

In some embodiments, the corners 32 of the fenestration unit 10 may define different intersection angles where the respective frame members 25 connect, including acute intersection angles, approximately right intersection angles, and obtuse intersection angles. For example, as shown in FIG. 1, the first corner 32a and the fourth corner 32d may respectively form a first intersection angle αₐ and a fourth intersection angle α_{d} of approximately 90 degrees. The second corner 32b may define an acute intersection angle α_{b} less than approximately 90 degrees. The third corner 32c may define an obtuse intersection angle α_{c} greater than approximately 90 degrees.

Each of the corner seals 36 may be coupled to portions of the corner 32 and extend radially outwardly relative to the frame 12. As shown, portions of the corner seals 36 may optionally be secured to a portion of the fin assembly 34 such as to the projection portion 33, the rough opening framing 4, and/or the structure 2. The corner seals 36 may be substantially similar to one another and thus are subsequently described collectively with regard to one corner seal 36 (although it should be apparent that differing configurations between each of the of corner seals 36 are also contemplated).

As described below, each of the corner seals 36 for the corners 32a-32d may be customized such that each of the corner seals 36 have features generally corresponding to each respective intersection angle α_{a-d} of the plurality of corners 32.

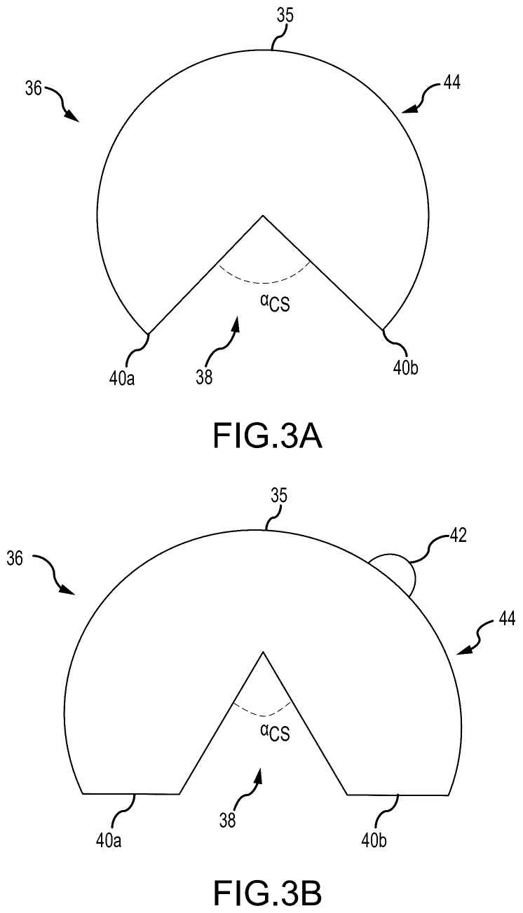

Turning to FIGS. 3A-3B, a front view of one corner seal 36 is shown. In some embodiments, the corner seal 36 includes a flange 35 and a cut-out area 38. As shown, the flange 35 may be rounded (e.g., circular) in shape. The rounded shape may help to avoid tearing or splitting when the corner seal 36 is flexed or stretched. Although rounded shapes are shown, it is also contemplated that polygonal shapes, rectangular shapes, or other shapes may also be utilized as desired.

The cut-out area 38 has edges 40a, 40b that define a corner seal angle α_{CS} generally corresponding to the intersection angle of the respective corner 32 that the corner seal 36 is applied to. For example, the corner seal 36 designated for the first corner 32 a may define a corner seal angle α_{CS} of approximately 90 degrees generally corresponding to the first intersection angle αₐ. The edges 40a, 40b may be generally pointed as shown in FIG. 3A, may be relatively flat, or “squared” as shown in FIG. 3B, or may be any shape there between. In some embodiments, and as further discussed below with respect to FIG. 4, at least a portion of the edges 40a, 40b are applied to the perimeter 13 of the frame 12 to secure the corner seals 36 to the fenestration unit 10. In this regard, each of the corner seals 36 may define different corner seal angle α_{CS}. In other embodiments, two or more of the corner seals 36 may define substantially the same corner seal angle α_{CS}. For example, a generally regular hexagonal fenestration unit (e.g., as shown in FIG. 9) may have six corners with a substantially similar intersection angle as each other.

FIG. 4 shows the corner seal 36 coupled to the fenestration unit 10 at the third corner 32c. Although discussed with respect to the third corner 32c, the corner seals 36 at each of the first corner 32a, the second corner 32b, and the fourth corner 32d may be configured in a substantially similar manner. As shown, the edges 40a, 40b are coupled to the perimeter 13 of the fenestration unit 10 and are coupled to a portion of the second and third fins 34b, 34c. As further discussed herein, the corner seals 36 may be coupled to the fenestration unit 10 when the fins 34 are in the deployed, extended position with the corner seals 36 being coupled to the projection portion 33. The corner seals 36 are positioned to overlay a portion of the fins 34 and the fin corners 41 (FIG. 2C). By coupling the corner seals 36 to the fins 34, gaps between the second and third fins 34b, 34c at the third corner 32c (e.g., at the third fin corner 41c) are covered. And, moreover, the gap 6 may also be covered by the corner seals 36. As shown, portions of the frame 12 are received by the cut-out area 38 such that the frame 12 extends within the space defined by the cut-out area 38. The flange 35 may extend radially outwardly relative to the frame 12 and couple to portions of the rough opening framing 4 and/or the structure 2 proximate to the third corner 32c. In some embodiments, and as further discussed below, the flange 35 may be configured to stretch and substantially pull material of the corner seal 36 taut to reduce instances of material bunching at the third corner 32c, which in turn improves weather sealing.

As shown in FIGS. 3B and 4, the corner seal 36 may also define one or more tabs 42 along a perimeter 44 of the flange 35 that extend outwardly relative to the perimeter 44. As further discussed below, the tab 42 may facilitate handling of the corner seal 36 during manufacturing and/or installation. In some embodiments, the tab 42 may be coupled to the corner seal 36 via a tear-off connection 46 (FIG. 4) such that the tab 42 is removable from the corner seal 36 before or after installation. As shown in FIG. 3B, the tab 42 may extend along a relatively small portion of the perimeter 44 of the flange 35. As shown in FIG. 4, the tab 42 may extend along a majority of the perimeter 44 of the flange 35.

In some embodiments, the corner seal 36 may comprise a flexible polymeric material, including but not limited to, polyethylene (e.g., a cross-linked polyethylene foam) or a thermoplastic elastomer such as Versaflex® CL40 Thermoplastic Elastomer (TPE) available from GLS Corp. The flexible polymeric material may have elastic properties allowing the corner seals 36 to exhibit desired flexibility and stretch while resisting failure such as tearing. As discussed below, the flexible polymeric material may include a pressure sensitive adhesive material including, but not limited to, a high strength acrylic or butyl.

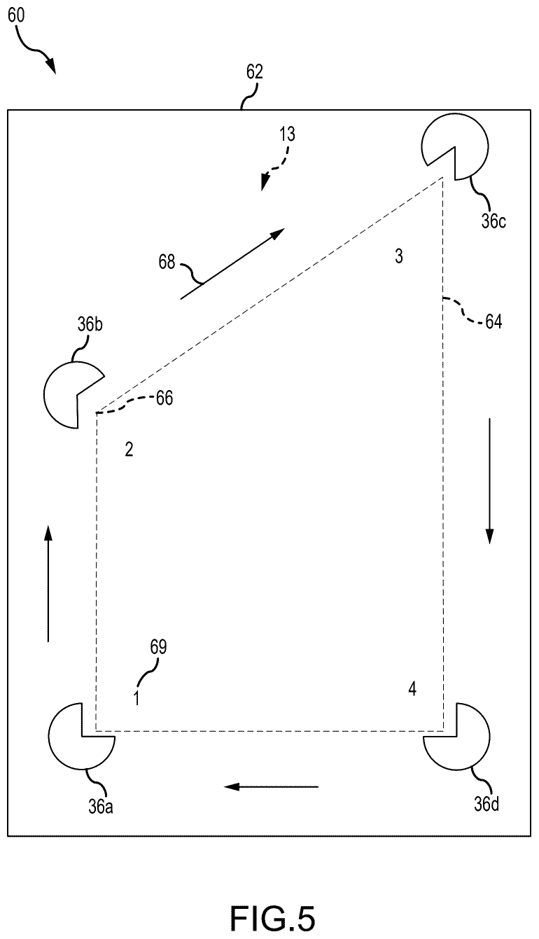

Turning to FIG. 5, a process of making a corner seal template 60 is described. The corner seals 36 may be manufactured at a remote manufacturing location prior to shipping the fenestration unit 10 and/or prior to initiating any on-site installation steps. Manufacturing the corner seals 36 includes, but is not limited to, steps of obtaining the intersection angle α of the corners 32, preparing the corner seal template 60, and optionally removing the corner seals 36 from the corner seal template 60.

Obtaining the intersection angle α of the corners 32 may include measuring the intersection angle α at one or more corners 32 of the plurality of corners 32. The measurements may be completed on the fenestration unit 10 after manufacturing the frame 12. The measurements may be taken manually or may be predetermined from an ordering system for each fenestration unit 10. For example, when the fenestration unit 10 of FIG. 1 is ordered, the ordering system may inform the manufacturer of each intersection angle of the corners 32. In some embodiments, one or more corners 32 may be substantially similar to one another. For example, in fenestration units 10 with symmetrical shapes and/or regular shapes with substantially equal angles the intersection angle of one corner 32 may be representative of each corner 32.

After obtaining the intersection angle α of the corner 32, a corner seal template 60 may be prepared. The corner seal template 60 is shown in FIG. 5. The corner seal template 60 includes a sheet of material 62 onto which the corner seals 36 will be formed. The sheet of material 62 may include the same flexible polymeric material as the corner seal 36 itself. As shown in FIG. 5, the corner seal template 60 includes a schematic 64 of an outline of the fenestration unit 10, which is intended to be a representation of the perimeter 13 of the fenestration unit 10 and acts as a guide for the manufacturer. The schematic 64 includes representations 66 of each corner 32 and each corner 32 is numbered 1 through n, where n is the total number of corners 32 of the fenestration unit 10. The corner seal template 60 many also include one or more designations 67 such as arrows 68 or alphanumeric symbols 69 indicating the number and/or order of the representations 66 of the corners 32 (e.g., one arrow 68 may point from the first corner to the second corner, another arrow 68 may point from the second corner to the third corner, and so on.) In general, the arrows 68 may point in a clockwise direction and indicate the lower left corner as the first corner 32a. The alphanumeric symbols 69 may be a sequence for guiding the installer that indicates which of the corners seals 36 should be installed at which corner 32.

In some embodiments, the corner seals 36 are laser cut into the sheet of material 62 adjacent to the representations 66 of the corner 32. By being positioned adjacent to each representation 66, the manufacturer and/or installer can quickly determine which corner seal 36 corresponds with which corner 32. The schematic 64, arrows 68, and/or alphanumeric symbols 69 may be laser cut onto the sheet of material 62 prior to forming the corner seals 36 thereon.

As discussed above, each of the corner seals 36 are customized to substantially match the intersection angle α at each corner 32. In particular, the cut-out area 38 of the corner seal 36 may be laser cut to have the corner seal angle α_{CS} closely matching the intersection angle α at the respective corner 32. In such embodiments, instructions for the intersection angle α at the corner 32 may be sent to the laser based on the obtained intersection angle measurements. The corner seal angle α_{CS} of the cut-out area 38 may be substantially equal to the intersection angle α of the corner 32. In other embodiments, the corner seal angle α_{CS} of the cut-out area 38 is between approximately 5% and 15% larger than the intersection angle α of the corner 32, optionally approximately 5% larger, between approximately 5% and 10% larger, between approximately 10% and 15% larger, or approximately 15% larger. By oversizing, there is a bias imparted onto the corner seal 36 encouraging stretching of the material of the corner seal 36 during installation, which helps to avoid bunching of excess material of the corner seals 36 about the corners 32 which can impact sealing. As shown, the corner seals 36 may be laser cut in a horseshoe shape including the flange 35 and the cut-out area 38.

In other embodiments, the corner seals 36 and/or the corner seal template 60 may be customized following a similar process as above and manufactured via a 3D-printing process. In still other embodiments, the corner seals 36 may be formed onto the corner seal template 60 via a stamping process facilitated by a variable punch and die cut, which allows for customized geometries for each corner seal 36.

A bulk manufacturing process for the corner seals 36 and/or the corner seal template 60 is also contemplated. The corners seals 36 may be manufactured using any of the above referenced methods (e.g., laser cutting, 3D printing, or stamping). For example, a selection of commonly used fenestration unit shapes and sizes (e.g., right triangles, isosceles triangles, trapezoids, and/or pentagons) may have predicable intersection angles for which a bulk set of corner seals 36 may be prepared ahead of receiving an order for the fenestration unit. Similarly, corner seals 36 for fenestration units with regular shapes (e.g., substantially equal angles at each corner, such as with a hexagon or octagon) may be manufactured in bulk.

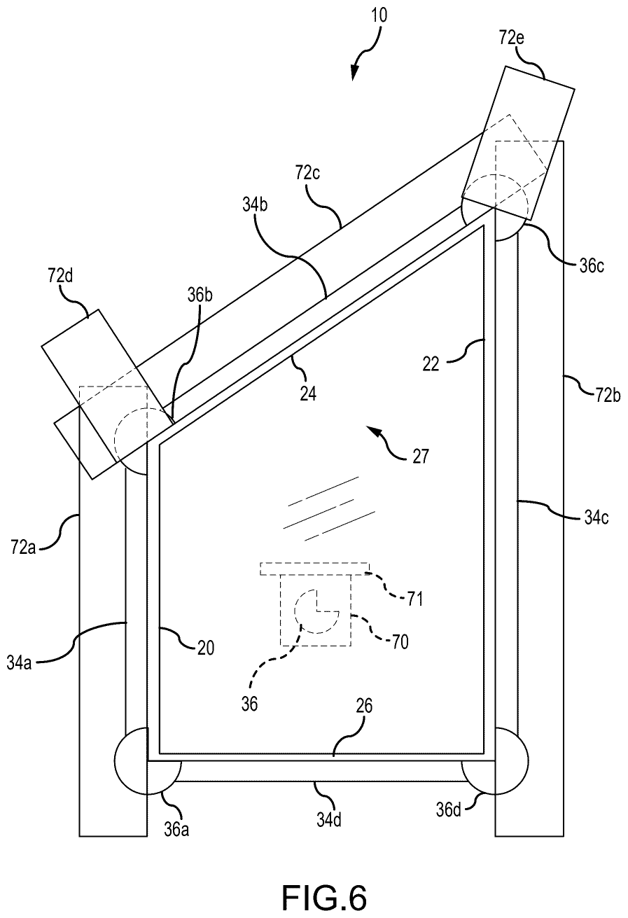

After preparing the corner seal template 60, the corner seals 36 may optionally be removed from the corner seal template 60. Upon removal, in some embodiments the corner seals 36 may be placed into a receptable, such as a bag 70 (FIG. 6), for shipping with the fenestration unit 10 to an installation site. The corner seals 36 may be stacked in a numerical order corresponding to the respective corner number or may be labeled with a number corresponding to the corner 32. The bag 70 may be coupled to a portion of the fenestration unit 10, such as the glazing panel 27 or the frame 12, for shipping. As shown in FIG. 6, the bag 70 may be adhered to the glazing panel 27 with a tape 71. In other embodiments, the entire corner seal template 60, including the schematic 64 may be shipped with the fenestration unit 10 to the installation site, and the installer may remove the corner seals 36 from the corner seal template 60 during installation. In such embodiments, the corner seal template 60 may act as an installation guide indicating which corner seal 36 corresponds to each corner 32.

One or more tabs 42 (FIGS. 3B and 4) may be laser cut with the corner seals 36 to facilitate removal of the corner seals 36 from the corner seal template 60. The one or more tabs 42 may be configured as a pull tab to remove the corner seal 36 from the remainder of the corner seal template 60. In other embodiments, the one or more tabs 42 may be removed after laser cutting (e.g., along the tear-off connection 46) leaving a recess or gap in the corner seal template 60 for ease of accessing and removing the corner seals 36.

In some embodiments, the sheet of material 62 may be configured as a carrier with an adhesive (not shown) and a removable liner (not shown) coupled to the adhesive. The adhesive may facilitate securing the corner seal 36 to the frame 12, the fins 34, and/or to the structure 2. The adhesive may include a pressure sensitive adhesive, including but not limited to, a high strength acrylic and/or butyl. When removing the corner seals 36 from the corner seal template 60, the liner may remain adhered to the corner seals 36 for shipping purposes. In other embodiments, an adhesive can be applied to the corner seal 36 and or the fenestration unit 10 remotely at the installation site during installation.

At the installation site, an installer may install the corner seals 36 onto the fenestration unit 10 after positioning and securing the fenestration unit 10 within the rough opening framing 4. In embodiments where the fin assembly 34 is included, prior to installing the corner seals 36, the fins 34 are transitioned to the extended state, or deployed configuration, in which the fins 34 extend radially outward relative to the frame 12 (e.g., as shown in FIG. 1).

The corner seals 36 may be removed from the bag 70 or may be removed from the corner seal template 60 prior to installation. Using the numbers on the corner seal template 60, or other identifiers on the corner seals 36 themselves, the installer identifies which corner seal 36 corresponds to which corner 32. Adhesive may then be applied to the corner 32 or corner seal 36, or alternatively, the liner may be removed from the corner seal 36 revealing the adhesive backing. Optionally, the one or more tabs 42 may be removed prior to initiating the installation steps or after completing at least one of the installation steps.

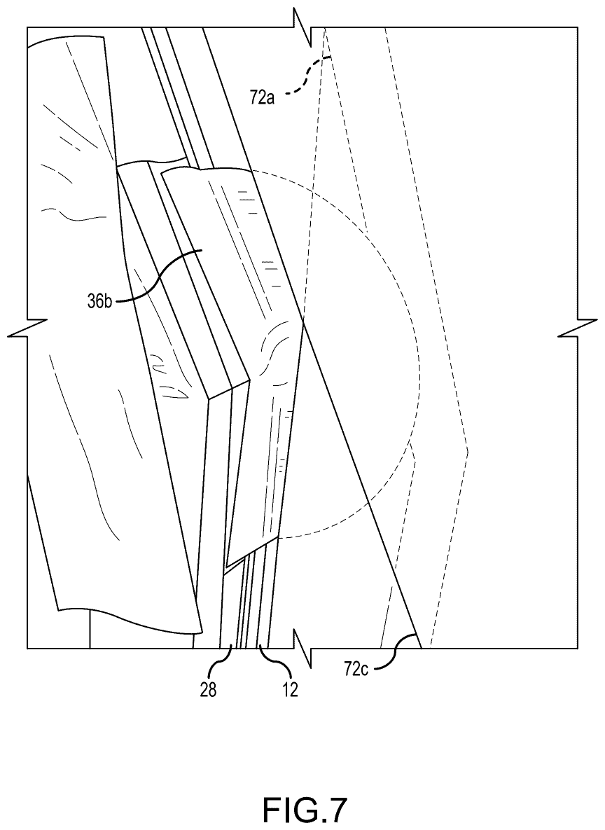

In some embodiments, installation steps include securing the edges 40a, 40b of the corner seal 36 to the perimeter 13 of the frame 12 at the respective corner 32. The edges 40a, 40b may be secured to the perimeter 13 by applying pressure onto the edges 40a, 40b. The edges 40a, 40b may be positioned such that the corner 32 of the frame 12 extends through the cut-out area 38 and the edges 40a, 40b are positioned on either side of the corner 32 (e.g., straddling the corner 32). The edges 40a, 40b may be coupled to the perimeter 13 at the same time or may be coupled sequentially. In some embodiments, the edges 40a, 40b are secured to the perimeter 13 between approximately ⅜ inch and ⅝ inch, or optionally ½ inch, from an exterior side 16 of the fenestration unit 10. The edges 40a, 40b may also be secured to a portion of the fins 34 (FIG. 4). Once the edges 40a, 40b are secured to the frame 12, the flange 35 is stretched radially outwardly relative to the frame 12 and secured to portions of one or more of the rough opening framing 4, the fins 34, and/or the structure 2. In instances of an acute corner angle (e.g., as shown in FIG. 4) the flange 35 may need to be stretched outwardly more than the corner seals 36 that are applied to corners 32 that define approximately right or obtuse angles (e.g., as shown in FIG. 7). Corner seals 36 at the right or obtuse corners may have less excess material relative to the acute corners 32 due to having less material (e.g., the cut-out area is relatively larger and the flange 35 is relatively smaller.) Stretching the material of the corner seal 36 during installation helps reduce instances of excess material bunching that may create gaps that interfere with weather sealing. The installer may repeat the above steps for each corner seal 36 at each corner 32.

Turning to FIGS. 8A-8B, in other embodiments, the corner seals 36 may be applied to the fins 34 at the manufacturing site prior to shipping the fenestration unit 10 to the installation site. Although shown and described with respect to the second corner 32b, a similar method may be followed for any corner 32 of the fenestration unit 10. With the fins 34b, 34c positioned with the projection portion 33 relatively flat against the frame 12 and an exterior-facing side 33a of the projection portion 33 facing outwards, the edges 40a, 40b of the corner seal 36 may be applied to the fins 34 at the respective fin corner 41. The fins 34 b, 34 c may then be folded approximately 180 degrees to the stowed, flattened configuration with the projection portion 33 flat against the frame 12 and the exterior-facing side 33a of the projection portion 33 against the perimeter 13 of the frame 12. As shown in FIG. 8A, during the transition toward the stowed, flattened configuration (FIG. 8B), the fins 34b, 34c may be in the deployed configuration in which the projection portion 33 projects away from the frame 12. In the deployed configuration, as shown in FIG. 8A, the corner seals 36 are stretched radially outward. Then, as shown in FIG. 8B, the fins 34b, 34c are transitioned to the stowed, flattened configuration in which the fins 34b, 34c are subsequently folded against the perimeter 13 of the frame 12. Here, the corner seal 36 is also folded against the perimeter 13 of the frame 12. After transitioning to the stowed, flattened configuration (FIG. 8B), the retaining assembly 29 is applied over at least a portion of the fins 34b, 34c to maintain both the fins 34b, 34c and corner seal 36 in the stowed, flattened configuration for shipping purposes. During installation at the installation site, once the retaining assembly 29 is removed, the fins 34b, 34c transition to the deployed configuration (FIG. 8A), and the corner seals 36 may be stretched radially and then applied to other portions of the fenestration unit 10 and/or structure 2 following a similar process as described above.

In some embodiments, during the installation of the corner seals 36, the installer may also apply flashing tape 72 along the exterior side 16 of the fenestration unit 10 and along at least a portion of the weather seal system 30. FIG. 6 illustrates the flashing tape installation process, and FIG. 7 shows an example of the flashing tape 72 installed at the second corner 32b, as an example. The flashing tape 72 and the corner seals 36 may be applied in a water shed fashion. For example, the corner seals 36 at the first corner 32a (e.g., the bottom left corner) and the fourth corner 32d (e.g., the bottom right corner) are installed first. Then, a first flashing tape 72a is applied along a portion of the weather seal system 30 including along the first fin 34a, optionally the first side member 20, and at least a portion of the first corner seal 36a. A second flashing tape 72b is then applied along the weather seal system 30 including along the third fin 34c, optionally the second side member 22, and at least a portion of the fourth corner seal 36d. After applying the first and second flashing tapes 72a, 72b, the corner seals 36 at the second corner 32b (e.g., the upper left corner) and the third corner 32c (e.g., the upper right corner) are installed following similar installation steps as discussed above. Then, a third flashing tape 72c is applied along another portion of the weather seal system 30 including along the second fin 34b, optionally along the upper member 24, and at least a portion of both the second corner seal 36b and the third corner seal 36c. Optionally, a fourth flashing tape 72d may be placed at the second corner 32b over each of the first and third flashing tapes 72a, 72c and the second corner seal 36b to cover any remaining gaps in the weather seal system 30. Similarly, a fifth flashing tape 72e may be placed at the third corner 32c over each of the second and third flashing tapes 72b, 72c and the third corner seal 36c. An interior air seal may then be applied along or under the flashing tapes 72a-72e. The interior air seal may include at least one of a low expansion foam, sealant, a backer rod, or combinations thereof (e.g., foam and sealant or the backer rod and sealant). As shown, the lower member 26 is devoid of flashing tape 72 and/or sealant, which allows for proper venting of the fenestration unit 10. For fenestration units with different geometries, a similar step-wise water shed installation process of installing both the corner seals 36 and the flashing tape 72 may be followed.

Although manufacturing and installation steps are discussed above with

respect to the trapezoidal fenestration unit 10, other fenestration unit geometries are contemplated, including but not limited to, hexagons, pentagons, octagons, and triangles. FIG. 9 shows a template 80 for a hexagonal fenestration unit 82. FIG. 10 shows a template 84 for a pentagonal fenestration unit 86. FIG. 11 shows a template 88 for an octagonal fenestration unit 90. FIG. 12 shows a template 92 for a triangular fenestration unit 94. All of the corner seals 36 for fenestration units 82, 86, 90, and 94 may be manufactured following similar manufacturing steps and installed onto the respective fenestration unit following similar installation steps as discussed above with respect to the fenestration unit 10. In some embodiments, the corners 32 of the respective fenestration units 82, 86, 90, and 94 may define substantially identical corner intersection angles such that each of the corner seals 36 may be substantially similar to each other and have substantially the same corner seal angle α_{CS}. In other embodiments, at least some of the corners 32 of the respective fenestration units 82, 86, 90, and 94 define different corner intersection angles such that the corner seal angle α_{CS} of the respective corner seals 36 differ from each other.

FIG. 13 shows a template 100 for the mulled fenestration unit 102. The mulled fenestration unit 102 may comprise more than one fenestration unit. FIG. 13 shows an example including a first fenestration unit 104, a second fenestration unit 106, a third fenestration unit 108, and a fourth fenestration unit 110, though any number of fenestration units are contemplated. The fenestration units 104, 106, 108, 110 may include different shapes and different dimensions. As shown, the first fenestration unit 104 is triangular and the second, third, and fourth fenestration units 106, 108, and 110 are generally rectangular, though any combination of shapes is contemplated. Corner seals 36 may be applied to the mulled fenestration unit 102 at intersection points between the fenestration units 104, 106, 108, 110 and/or at one or more corners of each respective fenestration unit 104, 106, 108, 110. As shown in FIG. 13, a first intersection point 112 between the first, second, and third fenestration units 104, 106, 108 may have the corner seal 36 applied thereto and a second intersection point 114 between the second, third, and fourth fenestration units 106, 108, 110 may have the corner seal 36 applied thereto. The corner seals 36 for the mulled fenestration unit 102 may be manufactured and installed onto the mulled fenestration unit 102 following similar processes as described above.

Various modifications and additions can be made to the exemplary embodiments discussed without departing from the scope of the present invention. For example, while the embodiments described above refer to particular features, the scope of the invention also includes embodiments having different combinations of features and embodiments that do not include all of the above-described features.

What is claimed is:

1. A method comprising:
creating an outline of a fenestration unit on a sheet of material, the outline including a representation of a corner of the fenestration unit; and
forming a corner seal into the sheet of material, wherein the corner seal includes a flange portion and a cut out area defining a corner seal angle that generally corresponds to an angle of the corner of the fenestration unit.

2. The method of claim 1, wherein forming the corner seal into the sheet of material includes laser cutting the corner seal into the sheet of material.

3. The method of claim 1, wherein forming the corner seal into the sheet of material includes locating the corner seal adjacent to the representation of the corner of the fenestration unit.

4. The method of claim 1, further including forming a tab along a perimeter of the corner seal.

5. The method of claim 1, further including creating a first designation on the template identifying the corner of the fenestration unit and a second designation identifying the corner on the outline of the fenestration unit, and optionally wherein the first and second designations are matching symbols, and optionally wherein the matching symbols are alphanumeric symbols.

6. The method of claim 1, further including removing the corner seal from the sheet of material.

7. A method of weather sealing a fenestration unit within a rough opening, the fenestration unit including a frame having a plurality of frame members defining a perimeter, wherein an intersection point between each frame member of the plurality of frame members defines a plurality of corners and each corner of the plurality of corners defines an angle, the method comprising:
securing a first corner seal to a first corner of the plurality of corners, wherein the first corner seal includes a flange portion and a cut out area defining a first corner seal angle that generally corresponds to a first angle of the first corner of the fenestration unit;
securing a second corner seal to a second corner of the plurality of corners, wherein the second corner seal includes a flange portion and a cut out area defining a second corner seal angle that generally corresponds to a second angle of the second corner of the fenestration unit; and
applying a flashing tape along a portion of the frame including over at least a portion of the first corner seal and a portion of the second corner seal.

8. The method of claim 7, wherein the fenestration unit includes one or more fins, the method further including transitioning the fins to an extended, deployed position prior to securing the first and second corner seals to the first and second corners.

9. The method of claim 7, further including securing a third corner seal to a third corner of the plurality of corners, wherein the third corner seal includes a flange portion and a cut out area defining a third corner seal angle that generally corresponds to a third angle of the third corner of the fenestration unit.

10. The method of claim 9, further including securing a fourth corner seal to a fourth corner of the plurality of corners, wherein the fourth corner seal includes a flange portion and a cut out area defining a fourth corner seal angle that generally corresponds to a fourth angle of the fourth corner of the fenestration unit.

11. The method of claim 10, further including applying a flashing tape along a portion of the frame including over at least a portion of the third corner seal and a portion of the fourth corner seal.

12. The method of claim 7, further comprising stretching at least a portion of the first corner seal radially outwardly relative to the frame.

13. The method of claim 7, further comprising removing a tab from the first corner seal.

14. The method of claim 7, further comprising following a corner seal template to determine an installation sequence of the corners of the fenestration unit.

15. A fenestration unit comprising:
a frame having a plurality of frame members defining a perimeter, wherein an intersection point between each frame member of the plurality of frame members defines a plurality of corners and each corner of the plurality of corners defines an intersection angle; and
at least one corner seal secured to a first corner of the plurality of corners, the at least one corner seal including a flange portion and a cut-out area defining a first corner seal angle that generally corresponds to a first intersection angle of the first corner of the fenestration unit.

16. The fenestration unit of claim 15, wherein the frame defines a geometry including one of a rectangle, a trapezoid, a triangle, a pentagon, a hexagon, an octagon, or a combination thereof.

17. The fenestration unit of claim 15, wherein the fenestration unit includes at least two fins and the at least one corner seal is secured to the at least two fins at an intersection point between the at least two fins.

18. The fenestration unit of claim 15, wherein the at least one corner seal includes a flexible polymeric material.

19. A template for a fenestration unit comprising:
a schematic of a perimeter of the fenestration unit including a representation of at least one corner of the fenestration unit; and
at least one corner seal positioned proximate to the at least one corner, the corner seal having a flange portion and a cut out area defining a first corner seal angle that generally corresponds to a first angle of the first corner of the fenestration unit.

20. The template of claim 19, further including at least one designation for each corner including at least one of arrows or alphanumeric symbols.
